(19) United States
(12) Patent Application Publication
(10) Pub. No.: US 2026/0029804 A1
(43) Pub. Date: Jan. 29, 2026

(54) SYSTEM AND METHOD FOR FLEXIBLE RELATIONAL MANEUVERING OF LEADER-FOLLOWER UNMANNED AERIAL VEHICLES

(71) Applicant: Board of Regents, The University of Texas System, Austin, TX (US)

(72) Inventors: Yongcan Cao, San Antonio, TX (US); David Casebeer, Dayton, OH (US); Praveen Ranjan, San Antonio, TX (US); Abhinav Sinha, Cincinnati, OH (US); Isaac Weintraub, Dayton, OH (US)

(21) Appl. No.: 19/281,286

(22) Filed: Jul. 25, 2025

Related U.S. Application Data
(60) Provisional application No. 63/675,725, filed on Jul. 25, 2024.

(51) Int. Cl. G05D 1/695; B64U 20/80; G05D 109/25

(52) U.S. Cl. CPC G05D 1/695; B64U 20/80; B64U 2201/104; G05D 2109/254

(57) ABSTRACT

A system and method for flexible relational maneuvering of a leader-follower unmanned aerial vehicle (UAV) system in 2D or 3D space are disclosed. The method uses onboard sensors to measure relative distance, line-of-sight angle, azimuth angle (in 3D), and the follower's bearing angle, controlling the follower's linear and angular speeds to maintain desired formation geometry. Proposed maneuvers include Heading-Alignment, Fixed Line-of-Sight, Fixed-Bearing Angle, and Constrained-Bearing Angle Formation Maneuvers, enabling dynamic positioning within a 2D ring or 3D partial hemispherical shell around the leader. Using only relative measurements, the system is robust in GPS-denied environments and suitable for heterogeneous UAVs. It emulates human pilot behavior for anticipatory maneuvers in applications like air-to-air combat, swarm operations, and urban air mobility.

### RELATED APPLICATIONS

This U.S. non-provisional patent application claims the benefit of U.S. Provisional Application No. 63/675,725 filed on Jul. 25, 2024, which is incorporated herein by reference in its entirety.

### FIELD

Certain aspects of the invention described are directed generally to the field of aviation and more particularly to unmanned aerial vehicle (UAV) aviation, including both two-dimensional (2D) and three-dimensional (3D) formation control strategies.

### BACKGROUND

Unmanned Aerial Vehicles (UAVs) have been used to a great extent to complete complex tasks such as reconnaissance, surveillance, target defense, and aerial refueling. Formation flight of multiple UAVs is a critical capability in many of these applications, involving the coordinated operation of the UAVs to achieve and maintain a specified geometric arrangement. Depending on the variables used to define the formation geometry, formation control laws can be broadly classified into three categories, namely position-based, distance-based, and bearing-based.

To maintain a formation, UAVs require coordination of flight variables, which may be sensed, measured, communicated, or estimated. Various formation control techniques in the literature rely on vehicle-to-vehicle communication, which can burden network resources. Additionally, most conventional approaches enforce rigid formations, constraining the follower to a fixed relative position or orientation with respect to the leader, limiting adaptability to dynamic conditions such as aggressive leader maneuvers or GPS-denied environments.

### SUMMARY

A new formation scheme is described for a leader-follower unmanned aerial vehicle (UAV) system, inspired by human pilot behavior, wherein the formation geometry can adapt dynamically in both 2D and 3D environments. This relational maneuvering scheme is termed “flexible” because the follower UAV's position and orientation relative to the leader can vary within predefined constraints during maneuvers, enabling anticipatory behavior akin to human pilots. The follower maintains a desired fixed relative distance from the leader while its orientation or bearing angle may adjust to reduce control effort, enhance energy efficiency, and provide tactical advantages, such as maintaining a position behind the leader. By assigning the follower's linear and angular velocities as control inputs, this approach emulates human pilot behavior, enabling the follower to execute anticipatory maneuvers in response to the leader's aggressive turns in 2D or 3D space. The proposed flexible geometry formation scheme is robust to changes in the leader's maneuvers, requiring only relative measurements and no information about the leader's angular speed or lateral acceleration. This makes the design effective for heterogeneous systems, GPS-denied environments, or non-cooperative leader scenarios. Simulations and experiments validate the approach, demonstrating its applicability to air-to-air combat, swarm UAV operations, and urban air mobility in both 2D and 3D contexts.

For the purposes of this specification and the appended claims, the following terms are defined as follows to ensure clarity and consistency in their usage:

Unmanned Aerial Vehicle (UAV): A UAV refers to an aircraft operated without a human pilot onboard, controlled either autonomously by onboard computers or remotely by a human operator. In this invention, UAVs include fixed-wing drones, quadrotors, or other aerial vehicles capable of executing controlled maneuvers in two-dimensional (2D) or three-dimensional (3D) space.

Leader-Follower System: A configuration involving two or more UAVs where one UAV, designated the “leader,” follows a predefined or dynamic trajectory, and one or more UAVs, designated as “followers,” adjust their positions and orientations relative to the leader to maintain a specified formation geometry in 2D or 3D space.

Flexible Formation: A formation control strategy where the follower UAV maintains a desired relative distance from the leader UAV while allowing its position and orientation to vary within a defined set of constraints, enabling adaptive maneuvers inspired by human pilot behavior, such as anticipatory turns or positional adjustments on a ring or partial hemispherical shell (3D) around the leader.

Heading-Alignment Formation Maneuver (HAFM): A control scheme where the follower UAV maintains a fixed distance r_{d} from the leader UAV and aligns its heading angle γ_{f} with the leader's heading angle γₗ, as defined herein.

Fixed Line-of-Sight Formation Maneuver (FLFM): A control scheme where the follower UAV maintains a fixed distance r_{d} and a fixed line-of-sight angle θ_{d} relative to the leader UAV, as defined herein.

Fixed-Bearing Angle Formation Maneuver (FBFM): A control scheme where the follower UAV maintains a fixed distance r_{d} and a fixed bearing angle σ_{fd} relative to the leader UAV, independent of the leader's angular speed or lateral acceleration, applicable in 2D or 3D context.

Relative Distance ((r)): The Euclidean distance between the leader and follower UAV, measured in 2D or 3D space, as shown in FIG. 1 and FIG. 2.

Line-of-Sight Angle (θ): The angle between the reference axis (e.g., the x-axis of the global coordinate frame) and the line connecting the leader UAV to the follower UAV, as shown in FIG. 1.

Line-of-Sight Angles (θ,ψ): In 2D, the line-of-sight angle θ is the angle between the reference axis (e.g., the x-axis of the global coordinate frame) and the line connecting the leader to the follower. In 3D, θ is the elevation angle and ψ is the azimuth angle of the line-of-sight, as shown in FIG. 2.

Bearing Angle (σ_{f}, σₗ): The angle between the velocity vector of a UAV (follower or leader) and the line-of-sight from the follower to the leader, denoted as σf for the follower and σl for the leader, as shown in FIG. 1 and FIG. 2.

Ring Angle (ϕ): The angle between the line-of-sight and the direction normal to the leader's velocity vector, measured anticlockwise, where π∈[0,π] indicates the follower is behind the leader, as shown in FIG. 4 and FIG. 7.

Control Inputs: The variables used to steer a UAV, including linear speed (vᵢ) and angular speed (co) for the follower (I=f) or leader (I=l) in homogeneous systems, or lateral acceleration (aₗ) for the leader in heterogeneous systems, pitch and yaw angular speeds (ω_{γi}, ω_{χi}) in 3D systems, as described herein.

Heterogeneous System: A leader-follower system where the leader and follower UAVs may have different control mechanisms, such as a fixed-wing leader steered by lateral acceleration and a quadrotor follower steered by linear and angular speeds, or differing 3D control inputs, as described herein.

GPS-Denied Environment: An operational scenario where Global Positioning System (GPS) signals are unavailable or unreliable, requiring the UAVs to rely on relative measurements (e.g., radar, lidar, or vision-based sensors) for navigation and control.

Barrier Lyapunov Function: A scalar function used to design control laws under state constraints, ensuring that error variables remain within a bounded domain.

Constrained-Bearing Angle Formation Maneuver (CBFM): A 3D control scheme where the follower UAV maintains a fixed distance r_{d} and constrains its bearing angle σ_{f} within predefined bounds ((a, b)), allowing convergence to a partial hemispherical shell behind the leader, as shown in FIG. 4.

These definitions are intended to provide a clear understanding of the terms used in this specification and are consistent with their usage in the field of UAV control systems. Additional terms may be defined as needed in the context of specific embodiments or claims.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 is a diagram illustrating the relative geometry of the leader-follower UAV system in 2D.

FIG. 2 is a diagram illustrating the 3D leader-follower engagement geometry.

FIG. 3 is a diagram illustrating the Heading-Alignment Formation Maneuver (HAFM) scheme in 2D.

FIG. 4 is a diagram illustrating the Fixed-Bearing Angle Formation Maneuver (FBFM) scheme in 3D.

FIG. 5 Constrained-Bearing Angle Formation Maneuver (CBFM) schemes in 3D.

FIG. 6 Show charts illustrating the performance of the Constrained-Bearing Angle Formation Maneuver (CBFM) in 3D for various leader maneuvers.

FIG. 7 is a diagram illustrating the ring angle, φ in 2D and 3D contexts.

FIG. 8 show charts illustrating the performance of the Heading-Alignment Formation Maneuver (HAFM).

FIG. 9 show charts illustrating the performance of the Fixed Line-of-Sight Formation Maneuver (FLFM).

FIG. 10 show charts illustrating the performance of the Fixed-Bearing Angle Maneuver (FBFM) in 2D when the leader is homogeneous (uₗ=[vₗ, ωₗ]^{T}).

FIG. 11 show charts illustrating the performance of the Fixed-Bearing Angle Maneuver (FBFM) in 2D when the leader is heterogeneous (uₗ=ωₗ).

FIG. 12 show charts illustrating the performance of the Fixed-Bearing Angle Maneuver (FBFM) in 2D when the leader is heterogeneous (uₗ=aₗ).

FIG. 13 show charts illustrating a comparison of the performance of the HAFM, FLFM, and FBFM relational maneuvering schemes.

### DETAILED DESCRIPTION

One of the earliest approaches for position-based automatic formation flight of leader-follower aircraft systems involves the use of first-order kinematics. Another method involves a relative state-based finite-time controller, where the follower vehicles estimate the leader's states and control input, thus requiring at least one of the followers to receive information from the leader. Another method uses a bearing-based formation controller for non-holonomic multi-robot systems, where the vehicles' control laws depended on each other's inputs, necessitating vehicle-to-vehicle communication. A formation controller based on track guidance has also been suggested that enables maneuvering formation on paths with sharp turns, which may also require communication in the position information of the desired path. Non-uniform vector fields also have been used to develop leader-follower formation control laws that are robust to wind disturbances.

The formation control laws in prior implementations require vehicle-to-vehicle communication. Multiple UAV formation control laws have also been suggested without explicitly depending on vehicle-to-vehicle communication, so that network resources are not over-burdened. For example, line-of-sight angle measurements may be used, where the follower vehicle being equipped with onboard sensors to obtain the measurements required to maintain formation. Relative angle-based leader-follower formation control laws use line-of-sight angle measurements and estimating the leader's state and control input. Distance-based formation control laws that are independent of each other's local frame orientation use only position measurements in a local reference frame. A formation strategy in consideration of a set of deviated pursuit guidance laws has also been developed by regulating the range and heading angle relative to the line-of-sight of the vehicles. Guidance laws can also be dependent on the formation geometry, which helps to realize a position-based formation without vehicle-to-vehicle communication. Unlike formation control laws that rely on continuous leader state estimation or assuming fixed local frame orientations, the present system and method use only relative measurements and allows the follower to vary its bearing angle independently, enhancing flexibility and robustness in GPS-denied applications. The proposed approach enables anticipatory maneuvers without vehicle-to-vehicle communication, reducing computational complexity.

In most conventional formation control schemes, the follower was constrained to be in a rigid formation with the leader, which is common in a close-proximity two-ship formation where maintaining a fixed geometry is crucial to the mission objectives. However, consideration of flexibility in formation geometry is more appealing from a practical perspective, enabling formations to adapt to changing conditions. Some studies have utilized time-varying formation shapes, enabling the agents to (re)form different shapes and then develop controllers that are robust to constraints such as time-varying topology, intermittent communications, actuator failure, and obstacle avoidance. For example, one scheme provides flexibility for the follower by reshaping the rigid formation structure depending on the leader's turn radius. Another formation control scheme utilizes fixed formation geometry in the x-y plane but allowed a variable altitude (z), thereby allowing some flexibility during the formation maneuvering. Another energy-efficient flexible formation scheme allows the follower to track the minimum energy path around the leader. Another set of formation maneuvering laws allow the follower some degree of flexibility by having a different orientation compared to the leader.

The present system and method are motivated by the need for flexible relational maneuvering of UAVs to reduce their maneuverability requirements during formation flight by letting the follower take a multitude of positions with respect to the leader in 2D and/or 3D environments. Human pilots have developed techniques and strategies over years of experience that allow them to fly efficiently and effectively. The present system and method emulate human pilot behaviors in UAVs, enabling these vehicles to adapt to changing conditions and unexpected events more effectively and efficiently. As a result, the system and method optimize the UAV flight patterns, reduce fuel consumption, increase mission effectiveness, and enhance situation awareness in leader-follower scenarios. Emulating these behaviors often requires flexibility in the vehicles' maneuverability. Conventionally, a leader-follower system translates or rotates as a single unit during formation. In contrast, the leader-follower system may not necessarily behave as a single unit because the follower tries to anticipate the leader's motion. Such maneuvers are typically relevant and of particular importance in air-to-air combat and other tactical, reconnaissance, and strategic missions. Therefore, we develop control for flexible formation that is inspired by a human pilot's behavior in various air-to-air combat scenarios. Various aspects of this work are summarized below:

The present system and method involve a flexible leader-follower formation scheme wherein flexibility endows the follower's ability to maintain (and possibly change if needed) its relative position within a certain set. Unlike previous works where flexibility implies formation reshaping, the ability to roto-translate in space, or scalability, this approach is less stringent since it allows the follower to stay within a larger set, namely, a multitude of positions relative to the leader, such as a ring in 2D or a partial hemispherical shell in 3D.

The system and method include three or four types of relational maneuvering techniques inspired by a human pilot's behavior, depending on the flight variable the follower tracks. All of these techniques exhibit varying levels of flexibility, allowing the follower to move independently of the leader's motion, where the leader-follower system behaves as a single unit that is distinct from prior schemes requiring fixed geometry or rigid formations. Therefore, there is no restriction on the follower's orientation in this approach, providing the follower flexibility to either take a longer route or a shortcut as necessary to stay in formation.

The present system and method also allow heterogeneity in the leader-follower UAV system, where the follower is always considered to be a small unmanned aerial vehicle while there is no such restriction on the class of vehicle for the leader. In contrast, most prior schemes assume the homogeneity of the vehicles that may warrant or require modifications if the class of leader vehicle changes.

The present system and method only require the relative information to be realized. Hence, in comparison to prior schemes, this design reduces the complexity of the leader-follower state space, demanding less computational effort and may not require vehicle-to-vehicle communications during formation, making it also appealing in GPS-denied and communication-degraded environments.

Consider two UAVs, namely, a leader and a follower. Assuming that the vehicles have non-holonomic constraints, and their motions in a plane are described by the following

$${\dot{x}}_{i} = υ cos {γ}_{i} , {\dot{y}}_{i} = {υ}_{i} sin {γ}_{i} , \qquad ( 1 )$$

$${\dot{γ}}_{f} - {ω}_{f} . \qquad ( 2 )$$

where the subscript i={l, f} denotes the leader (l) and the follower (f), [xᵢ, yᵢ]^{T}∈R² represents their instantaneous positions, vᵢ∈R_{≥0} is their linear speeds, γᵢ∈[−π, π] is their heading angles, and ω_{f}∈R is the follower's turn rate. The leader's heading dynamics depend on its control inputs, as described below. In 3D, their motions in an inertial frame with axes X_{I}, Y_{I}, Z_{I} are described by:

$${\dot{x}}_{i} = {υ}_{i} cos {γ}_{i} cos {χ}_{i} ,$$

$${\dot{γ}}_{i} = {υ}_{i} cos {γ}_{i} sin {χ}_{i} ,$$

$${\dot{z}}_{i} = {υ}_{i} sin {γ}_{i}$$

$${\dot{γ}}_{i} = {ω}_{{γ}_{i}} ,$$

$${\dot{χ}}_{i} = \frac{{{ω}_{χ}}_{i}}{cos {γ}_{i}}$$

where γᵢ∈(−π/2, π/2) is the flight path angle, χᵢ∈(−π, π] is the heading angle, and ω_{γi}, ω_{χi}∈R are the pitch and yaw angular speeds, respectively.

The follower is steered by its linear and angular speeds, that is, its control input, u_{f}=[v_{f}, ω_{f}]^{T}∈R², is such that v_{f}∈R_{≥0} and ω_{f}∈R. However, depending on the class of vehicle, the leader may have a different set of steering controls. For instance, if the leader is a fixed-wing drone, then it is pragmatic to consider the leader's turn rate as

$${ω}_{l} = \frac{{a}_{l}}{{υ}_{l}}$$

where aₗ∈R is the lateral acceleration of the leader, which is applied perpendicular to its speed in its body-fixed frame, which is also the natural direction of lift in such vehicles. In this case, the leader changes its orientation by manipulating its heading using lateral acceleration only while maintaining a constant speed. Alternatively, the leader may be steered by its turn rate alone if it is a small UAV (e.g., quadrotors), i.e.,

$${\dot{γ}}_{l} = {ω}_{l}$$

where ωₗ∈R is the leader's turn rate. However, if the vehicles are homogeneous, then the leader's control inputs are its linear and angular velocities, that is, uₗ=[vₗ, ωₗ]^{T} ∈R² such that vₗ ∈R_{≥0} and ω₁ ∈R. In 3D, the follower's control input is u_{f}=[v_{f}, ω_{γ}_{_{f}}, ω_{χ}_{_{f}}]∈ [symbol] , and the leader's control input is uₗ=[vₗ, ω_{γ}_{ₗ}, ω_{χ}_{ₗ}]^{T}∈ [symbol] for homogeneous systems, with bounded inputs vₗ∈[vₗ,v̅ₗ], |ω_{γ}_{ₗ}|<ω_{γ′}, and |ω_{χ}_{ₗ}|<ω_{χ′}.

Assumption 1. The leader and the follower vehicles are point mass objects. Further, the leader's control inputs are bounded, that is, vₗ≤vₗ≤vₗ with 0≤vₗ<vₗ<∞. Similarly, depending on the type of leader vehicle, |ωₗ|<ωₘ<∞ or |aₗ|<aₘ<∞, or in 3D |ω_{γl}|<ω_{γ}<∞, where vₗ, vₗ, ωₘ, aₘ, ω_{γ}, ω_{χ} are positive constants.

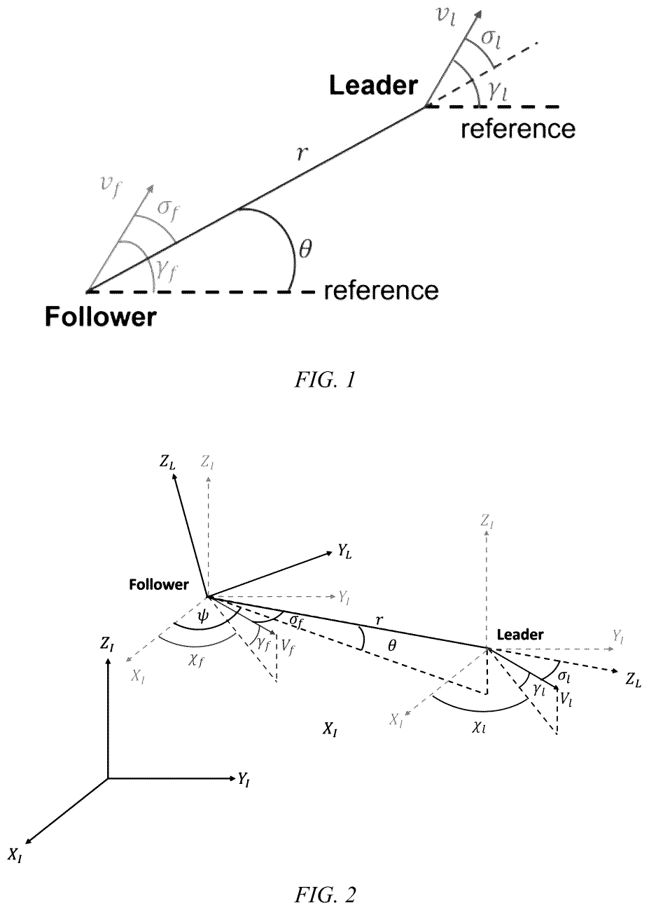

Assumption 1 is reasonable as the available control effort for any vehicle is limited in practice. Before formally discussing the problem statement, an alternate set of representations of the above dynamics is chosen based upon relative measurements only and is shown in FIG. 1 (2D) and FIG. 2 (3D), as

$$\dot{r} = {v}_{l} cos {σ}_{l} - {v}_{f} cos {σ}_{f}$$

$$r \dot{θ} = {v}_{l} sin {σ}_{l} - {v}_{f} sin {σ}_{f}$$

$$\dot{r} = {v}_{l} cos ( {γ}_{l} - θ ) - {v}_{f} cos ( {γ}_{f} - θ ) , \qquad ( 5 a )$$

$$r \dot{θ} = {v}_{l} sin ( {γ}_{l} - θ ) - {v}_{f} sin ( {γ}_{f} - θ ) , \qquad ( 5 b )$$

$${σ}_{f} = {γ}_{f} - {θ}_{f} , \qquad ( 5 c )$$

where (r) is the distance between the vehicles at any moment of time, θ is the line-of-sight angle, and σ_{f} is the follower's bearing angle. In 3D, the relative motion is governed by:

$$\dot{r} = {v}_{l} ( sin θ sin {γ}_{l} + cos θ cos {γ}_{l} cos ( ψ - {χ}_{l} ) ) - {v}_{f} ( sin θ sin {γ}_{f} + cos θ cos {γ}_{f} cos ( ψ - {χ}_{f} ) )$$

$$r \dot{θ} = {v}_{l} ( sin {γ}_{l} cos θ - cos ( {χ}_{l} - ψ ) cos {γ}_{l} sin θ ) - {v}_{f} ( sin {γ}_{f} cos θ - cos ( {χ}_{f} - ψ ) cos {γ}_{f} sin θ )$$

$$r cos θ \dot{ψ} = {v}_{l} sin ( {χ}_{l} - ψ ) cos {γ}_{l} - {v}_{f} sin ( {χ}_{f} - ψ ) cos {γ}_{f}$$

where θ∈(−π/2, π/2) is the line-of-sight elevation angle, ψ∈(−π/2, π/2] is the azimuth angle, and the bearing angle σᵢ is defined as:

$$cos {σ}_{i} = cos {γ}_{i} cos θ cos ( {χ}_{i} - ψ ) + sin {γ}_{i} sin θ$$

for i∈{l,f}, with σ∈[0,π].

The relational maneuvering of leader-follower UAVs is described by the following definitions.

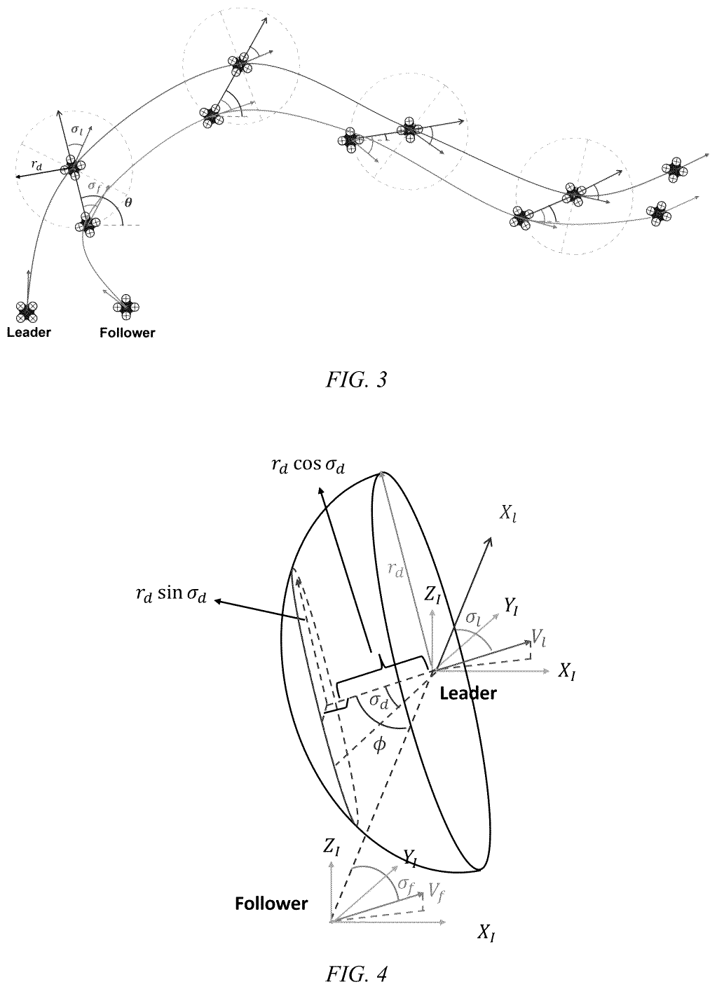

Heading-alignment Formation Maneuver (HAFM). The follower is said to be in HAFM with the leader if the follower remains at a fixed distance r_{d}∈R_{≥0} from the leader and maintains the same heading angle as that of the leader, that is, γ_{f}=γₗ (FIG. 3).

Fixed Line-of-sight Formation Maneuver (FLFM). The follower is said to be in FLFM with the leader if the follower maintains a fixed distance r_{d} and a fixed line-of-sight angle with respect to the latter (FIG. 9).

Rather than matching their heading angles, the follower now tries to maintain a fixed line-of-sight angle in FLFM, that is, θ→θ_{d}, where θ_{d}∈(−π, π] is the desired value of θ.

Fixed-bearing Angle Formation Maneuver (FBFM). The follower is said to be in FBFM with the leader if the follower maintains a fixed distance r_{d} and a fixed desired bearing angle with respect to the latter (FIG. 4).

In FBFM, however, the bearing angle of the follower attains the desired value independent of the line-of-sight angle or the leader's bearing angle, and the follower maintains a fixed relative distance from the leader. This essentially means that σ_{f}→σ_{fd} for some desired follower's bearing angle

$${σ}_{{f}_{d}} ∈ [ - \frac{π}{2} + δ , \frac{π}{2} - δ ] and δ ∈ ( 0 , \frac{π}{2} ]$$

is a parameter.

Constrained-Bearing Angle Formation Maneuver (CBFM). The follower is said to be in CBFM with the leader if the follower maintains a fixed distance r_{d} and constrains its bearing angle σ_{f} within predefined bounds a<σ_{f}<b, where 0≤a<b≤π/2, converging to a partial hemispherical shell behind the leader (FIG. 4).

These formation maneuvers are also observed in human pilots in various air-to-air combat situations (e.g., in leader-wingman formations and dogfights) when they carry out different maneuvers, e.g., a wedge, fighting wing, or lead/lag pursuit. Effectively, this defines a ring around the leader in 2D such that the follower can slide along to anticipate the leader's motion and maintain the flexible formation (FIG. 7). In 3D, CBFM defines a partial hemispherical shell, allowing the follower to converge to any point within a set of allowable positions, enhancing maneuverability. The present system and method emulate such behaviors in small autonomous vehicles by allowing various degrees of flexibility in the relational maneuvering of a leader-follower UAV system.

Assumption 2. The follower is behind the leader if cos σₗ>0, or equivalently ϕ∈[0,π/2), if otherwise it is ahead of the leader. In 3D, this implies the follower is in the hemisphere behind the leader where the ring angle ϕ=σₗ.

This notion of staying ahead/behind the leader is also crucial to design a relational maneuvering strategy for flexible geometry formation. In particular, if the follower stays behind the leader, then it may gain a tactical advantage, which is also similar to a human pilot's behavior. The notion of staying behind in Assumption 2 also imposes mild conditions on the trajectory of the leader and guarantees that the leader has no components of its velocity pointed toward the follower. As shown in FIG. 7, the method defines a ring angle, φ, as the angle between the line-of-sight and the direction normal to the leader's velocity vector (measured anticlockwise relative to the leader's velocity vector), such that φ∈[0, π] denotes the follower being behind the leader. Note that if φ is a constant value as the leader maneuvers, then the formation is not flexible as the whole formation shape would change its orientation relative to that of the leader. In 3D, the follower's position set in CBFM is defined as ζ={ϕ∈R²|r=r_{d},σ_{f}∈(a,b)}, representing a partial hemispherical shell.

In summary, the present formation control strategy provides that r→r_{d} and
(1) γ_{f}→γₗ, namely, HAFM
(2) θ→θ_{d}, namely, FLFM
(3) σ_{f}→σ_{fd}, namely, FBFM
(4) σ_{f} ∈(a, b), namely, CBFM
   as time progresses.

The follower's linear speed is such that it converges to the desired relative distance, r_{d} (a ring around the leader in 2D or a sphere in 3D). The range error is defined as:

$${e}_{r} = r - {r}_{d} , \qquad ( 6 )$$

whose time differentiation results in

$${\dot{e}}_{r} = \dot{r} = {v}_{l} cos {σ}_{l} - {v}_{f} cos {σ}_{f}$$

$${\dot{e}}_{r} = \dot{r} - {\dot{r}}_{d} = \dot{r}$$

since \dot{r}_{d}=0. Substituting from the relative motion equations yields

$${\dot{e}}_{r} = {v}_{l} cos {σ}_{l} - {v}_{f} cos {σ}_{f}$$

In 3D, the range error dynamics are:

$$\dot{{e}_{r}} = {v}_{l} ( sin θ sin {γ}_{l} + cos θ cos {γ}_{l} cos ( ψ - {χ}_{l} ) ) - {v}_{f} ( sin θ sin {γ}_{f} + cos θ cos {γ}_{f} cos ( ψ - {χ}_{f} ) )$$

The follower's linear speed is the following:

$${v}_{f} = {v}_{l} cos {σ}_{l} + {K}_{r} sign ( {e}_{r} ) \qquad ( 9 )$$

$${v}_{f} = \frac{{v}_{l} cos {σ}_{l} + {K}_{r} sign ( {e}_{r} )}{cos {σ}_{f}} ,$$

where Kᵣ>0 is the controller gain such that the range error (6) vanishes within a finite time |eᵣ(0)|/Kᵣ. in 3D, the linear speed control is:

$${v}_{f} = \frac{{v}_{l} ( sin θ sin {γ}_{l} + cos θ cos {γ}_{l} cos ( ψ - {χ}_{l} ) ) + {K}_{r} sign ( {e}_{r} )}{sin θ sin {γ}_{f} + cos θ cos {γ}_{f} cos ( ψ - {χ}_{f} )}$$

Theorem 1. Consider the leader-follower motion kinematics, in 2D or 3D. The follower's linear speed control law, v_{f} in the respective 2D or 3D, enables it to converge on a ring of radius r_{d} around the leader in 2D or a sphere in 3D within a finite time.

Proof. A Lyapunov function candidate based on the error is

$${V}_{{e}_{r}} = \frac{1}{2} {e}_{r}^{2} .$$

On differentiating Vₑᵣ with respect to time, and substituting via the respective range error dynamics, results in

$${\dot{V}}_{{e}_{r}} = {e}_{r} {\dot{e}}_{r} = {e}_{r} ( {υ}_{l} cos {σ}_{l} - {υ}_{f} cos {σ}_{f} )$$

In 3D,

$${\dot{V}}_{{e}_{r}} = {e}_{r} [ {v}_{l} ( sin θ sin {γ}_{l} + cos θ cos {γ}_{l} cos ( ψ - {χ}_{l} ) ) - {v}_{f} ( sin θ sin {γ}_{f} + cos θ cos {γ}_{f} cos ( ψ - {χ}_{f} ) ) ]$$

It follows that on letting v_{f} as that in the respective 2D or 3D form,

$${\dot{V}}_{{e}_{r}} = - {K}_{r} \vert {e}_{r} \vert < 0 ∀ {e}_{r} ∈ ℝ \backslash \{ 0 \}$$

if Kᵣ is chosen to be positive. This, in turn, implies that under the proposed speed control, the range error decays to zero, eventually making the follower converge on the ring (whose radius is r_{d}) around the leader in 2D or sphere in 3D. Upon using the proposed v_{f}, the closed-loop range error dynamics can be further written as

$${\dot{e}}_{r} = - {K}_{r} sign ( {e}_{r} ) , \qquad ( 12 )$$

which can be integrated within the limits |eᵣ(0)| to zero to compute the time of error convergence. It is then immediate that eᵣ vanishes within a finite time given by |eᵣ(0)|/Kᵣ. This completes the proof.

Remark 1. When the follower converges on the ring around the leader in 2D or sphere in 3D, r=r_{d} or eᵣ=0. This also leads to the observation that

$$\begin{matrix}\dot{r} = {v}_{l} cos {σ}_{l} - {v}_{f} cos {σ}_{f} = 0 \\ {\dot{e}}_{r} = {v}_{l} cos {σ}_{l} - {v}_{f} cos {σ}_{f} = 0 ,\end{matrix}$$

### In 3D,

$$\dot{r} = {v}_{l} ( sin θ sin {γ}_{l} + cos θ cos {γ}_{l} cos ( ψ - {χ}_{l} ) ) - {v}_{f} ( sin θ sin {γ}_{f} + cos θ cos {γ}_{f} cos ( ψ - {χ}_{f} ) ) = 0$$

that is,

$${v}_{f} = {v}_{l} ( \frac{cos {σ}_{l}}{cos {σ}_{f}} ) .$$

### Suppose

$${σ}_{f} ∈ ( - \frac{π}{2} , \frac{π}{2} ) ,$$

which means that 0<cos σ_{f}<1. Additionally, when

$${σ}_{f} ∈ ( - π , - \frac{π}{2} ) ⋃ ( \frac{π}{2} , π ] ,$$

then −1<cos σ_{f}<0. By combining these two cases, v_{f}=α vₗ cos σₗ, where α is a time-varying scalar such that α>1 when

$${σ}_{l} ∈ ( - \frac{π}{2} , \frac{π}{2} ) ,$$

otherwise α<1. Moreover, since v_{f}∈R_{≥0}, the term α cos σₗ has to be non-negative as vₗ−R_{≥0} and

$${σ}_{l} ∈ ( - \frac{π}{2} , \frac{π}{2} )$$

(due to Assumption 2). This is possible only when the sign of σ_{f} and σₗ are the same in the steady state. In other words,

$${σ}_{f} ∈ ( - \frac{π}{2} , \frac{π}{2} )$$

when the follower converges on the ring or sphere.

From the steady state condition, v_{f}=vₗ when σ_{f}=σₗ. In other words, when the bearing angles, σ_{f}, of the leader and the follower are equal, their velocities are equal.

The turn rate or the angular speed of the follower should be designed to meet the objectives of various formation control schemes discussed above. Unlike the follower's linear speed control law, which does not depend on the leader's turn rate, the follower's angular speed may have some relationship with its linear speed to maintain formation with the leader.

HAFM. In an HAFM, the objective is to drive the follower's heading angle to be the same as the leader's. Hence, the error in their heading angles, e_{γ}=γ_{f}−γₗ, needs to be driven to zero via a suitable ω_{f}. The following angular speed control laws are proposed for the follower when the leader is steered differently.

Proposition 1. Consider the leader-follower motion kinematics in 2D, where uₗ=[vₗ, ωₗ]^{T} for a homogenous leader or uₗ=ωₗ for a heterogeneous leader. The follower's angular speed control law

$${ω}_{f} = {ω}_{l} - {K}_{{γ}_{l}} sign ( {e}_{γ} ) ; {K}_{{γ}_{l}} > 0$$

enables it to maintain the same heading angle as that of the leader during formation.

Proof. Choose a Lyapunov function candidate,

$${V}_{γ} = \frac{1}{2} {e}_{γ}^{2} .$$

Time differentiation of this Lyapunov function candidate yields

$$\begin{matrix}{\dot{V}}_{γ} = {e}_{γ} {\dot{e}}_{γ} = {e}_{γ} ( {γ}_{f} - {γ}_{l} ) = {e}_{γ} ( {ω}_{f} - {ω}_{l} ) \\ {\dot{V}}_{γ} = {e}_{γ} {\dot{e}}_{γ ,}\end{matrix}$$

which can be simplified to

$${\dot{V}}_{γ} = {e}_{γ} ( {ω}_{f} - {ω}_{l} ) ,$$

It follows from that the proposed angular speed control law renders the time derivative of the Lyapunov function candidate as,

$${\dot{V}}_{γ} = - {K}_{{γ}_{l}} \vert {e}_{γ} \vert < 0 ∀ {e}_{γ} ∈ ℝ \backslash \{ 0 \}$$

if K_{γ1} is chosen to be positive. This infers that the heading angle error decays to zero due to (14), hence making the follower match its heading angle with that of the leader eventually. This completes the proof.

Upon using the proposed ω_{f}, the closed-loop heading angle error dynamics becomes, e_{γ}=−K_{γ1} sign(e_{γ}), which gives us a finite time for the convergence of e_{γ} as |e_{γ}(0)|/K_{γ1}. This inference is the same as that in the case of linear speed control in the previous section. Furthermore, as e_{γ} becomes zero, γ_{f}=γₗ, which also implies that of ω_{f}=ωₗ and γ_{f} ⊂θ=γₗ−θ, leading to σ_{f}=σₗ. Additionally, from the previous observation via the linear speed controller, v_{f}=vₗ on the ring when σ_{f}=σₗ.

Remark 2. From the relative speed components, Vr=\dot{r} and V_{θ}=rθ, one has,

$$tan {σ}_{l} = \frac{{V}_{θ}}{{V}_{r}} = \frac{r \dot{θ}}{\dot{r}}$$

$$\frac{{V}_{θ}}{{V}_{r}} = \frac{{v}_{l} sin {σ}_{l} - {v}_{f} sin {σ}_{f}}{{v}_{l} cos {σ}_{l} - {v}_{f} cos {σ}_{l}} = \frac{( {v}_{l} - {v}_{f} ) sin {σ}_{f}}{( {v}_{l} - {v}_{f} ) cos {σ}_{f}} = tan {σ}_{f} , \qquad ( 18 )$$

or equivalently, V_{θ}/Vᵣ=tan σₗ. Now, when σ_{f}→0, then V_{θ}→0. This essentially means that rθ^{⋅}=0, which makes the line-of-sight angle fixed eventually. If, however,

$${σ}_{f} \to \pm \frac{π}{2} ,$$

then Vᵣ→0, meaning that \dot{r}→0. In those cases, the situation that \dot{r} becomes zero before the follower converges on the ring may be problematic as there won't be enough control authority to correct the range error. Since v_{f}→vₗ and γ_{f}→γₗ by design, σ_{f} does not take extreme values of

$$\pm \frac{π}{2} .$$

Therefore, the conclusion is that the control laws are nonsingular if Assumption 2 is not violated.

Another angular speed control law is proposed for the follower when the leader is heterogeneous and is steered only by its lateral acceleration. In this case, the leader maintains a constant linear speed and changes its heading by manipulating its lateral acceleration according to (3). The proof is omitted herein since it follows the same principle as that of Proposition 1.

Corollary 1. Consider the leader-follower motion kinematics in 2D, where uₗ=aₗ. The follower's angular speed control law

$${ω}_{f} = \frac{{a}_{l}}{{υ}_{l}} - {K}_{γ 2} sign ( {e}_{γ} ) ; {K}_{γ 2} > 0$$

enables it to maintain the same heading angle as that of the leader during formation.

In this case, the follower maintains a turn rate equal to that of the leader in the steady state, and other inferences remain the same, as discussed in Remark 2.

FLFM. In the FLFM scheme, the follower's objective is to maintain a fixed line-of-sight angle, that is,

$${e}_{θ} = θ - {θ}_{d} ,$$

where θ_{d} is the desired value of the line-of-sight angle such that

$${\dot{e}}_{θ} = \dot{θ} \\ {\dot{e}}_{θ} = \dot{θ} = \frac{{υ}_{l} sin ( {γ}_{l} - θ ) - {υ}_{f} sin ( {γ}_{f} - θ )}{r}$$

Suppose the leader and the follower are homogeneous, that is, uₗ=[vₗ, ωₗ]^{T}. The following is obtained

$$( 22 )$$

$${\ddot{e}}_{θ} = \frac{{v}_{l} sin ( {γ}_{l} - θ ) - {v}_{f} sin ( {y}_{f} - θ )}{r} + \frac{\begin{matrix}{\dot{v}}_{l} sin ( {γ}_{l} - θ ) - {\dot{v}}_{f} sin ( {γ}_{f} - θ ) + \\ {v}_{l} {ω}_{l} cos ( {γ}_{l} - θ ) - {v}_{f} {ω}_{f} cos ( {γ}_{f} - θ )\end{matrix}}{r} \\ {\ddot{e}}_{θ} = \frac{1}{r} [ \text{} - 2 \dot{r} \dot{θ} + {υ}_{l} {ω}_{l} cos ( {γ}_{l} - θ ) + {\dot{υ}}_{l} sin ( {γ}_{l} - θ ) - {\dot{υ}}_{f} sin ( {γ}_{f} - θ ) - {υ}_{f} {ω}_{f} cos ( {γ}_{f} - θ ) ] ,$$

where the 2D kinematics are used to arrive at (22).

It should be noted that such a scheme demands that the information of the derivative of the leader's speed control input be known in addition to several engagement variables, which may not be reasonable to obtain in practice in many scenarios. If the leader is heterogeneous, that is, for uₗ=ωₗ with a constant vₗ,

$${\ddot{e}}_{θ} = \frac{{v}_{l} sin ( {γ}_{l} - θ ) - {v}_{f} sin ( {y}_{f} - θ )}{r} + \frac{{v}_{l} {ω}_{l} cos ( {γ}_{l} - θ ) - {v}_{f} {ω}_{f} cos ( {γ}_{f} - θ )}{r} \\ {\ddot{e}}_{θ} = \frac{1}{r} [ \text{} - 2 \dot{r} \dot{θ} + {υ}_{l} {ω}_{l} cos ( {γ}_{l} - θ ) - {\dot{υ}}_{f} sin ( {γ}_{f} - θ ) - {υ}_{f} {ω}_{f} cos ( {γ}_{f} - θ ) ] , \qquad ( 23 )$$

and for uₗ=aₗ with a constant vₗ, ë_{θ} can be expressed as

$${\ddot{e}}_{θ} = \frac{{v}_{l} sin ( {γ}_{l} - θ ) - {v}_{f} sin ( {y}_{f} - θ )}{r} + \frac{{a}_{l} cos ( {γ}_{l} - θ ) - {v}_{f} {ω}_{f} cos ( {γ}_{f} - θ )}{r} \\ {\ddot{e}}_{θ} = \frac{1}{r} [ \text{} - 2 \dot{r} \dot{θ} + {a}_{l} cos ( {γ}_{l} - θ ) - {\dot{υ}}_{f} sin ( {γ}_{f} - θ ) - {υ}_{f} {ω}_{f} cos ( {γ}_{f} - θ ) ] . \qquad ( 24 )$$

In all of these cases, it is worth noticing that such a scheme also requires the derivative of the follower's speed control, which may not always be satisfactory.

One way to go around would be to consider the higher-order terms as bounded uncertainties that are lumped. To this end, rewrite ë_{θ} (for uₗ=[vₗ, ωₗ]^{T} and uₗ=ωₗ) as

$${\ddot{e}}_{θ} = \frac{Δ}{r} - \frac{{v}_{f} cos ( {γ}_{f} - θ )}{r} {ω}_{f} \\ {\ddot{e}}_{θ} = \frac{1}{r} [ \text{} - 2 \dot{r} \dot{θ} + {υ}_{l} {ω}_{l} cos {σ}_{l} - {υ}_{f} {ω}_{f} cos {σ}_{f} + Δ ] , \qquad ( 25 )$$

where we have simplified (24) by writing σₗ=γₗ−θ, σ_{f}=γ_{f}−θ, and Δ=vₗ sin(γₗ−θ)−v_{f} sin(γ_{f}−θ) such that |Δ|≤vₗ+v_{f}≤η for some η∈R_{≥0}. Now, we propose the follower's angular speed control to steer it to the desired line-of-sight angle as

$${ω}_{f} = \frac{sign ( cos ( {γ}_{f} - θ ) )}{{v}_{f} cos ( {γ}_{f} - θ )} [ η sign ( ζ ) + {K}_{θ} ζ ] \\ {ω}_{f} = \frac{r [ ( λ - \frac{2 \dot{r}}{r} ) \dot{θ} + {K}_{θ} sign ( ζ ) ] + {υ}_{l} {ω}_{l} cos {σ}_{l}}{{υ}_{l} cos {σ}_{l} + {K}_{r} sign ( {e}_{r} )} , \qquad ( 26 )$$

where λ∈R_{≥0} is a parameter, K_{θ} is the gain of the controller to be designed later, and

$$ζ = {\dot{e}}_{θ} + λ {e}_{θ} .$$

Proposition 2. Consider the leader-follower motion kinematics given in 2D. The follower's angular speed control law ensures that the follower maintains a fixed line-of-sight angle θ_{d} during formation if

$${K}_{θ} > \frac{ηλ}{r} \\ {K}_{θ} > {sup}_{t \geq 0} \frac{η}{r} . \qquad ( 28 )$$

Proof. Consider a Lyapunov function candidate,

$${V}_{θ} = \frac{1}{2} {ζ}^{2} .$$

Differentiating V_{θ} with respect to time and further simplifications using the expression leads to

$$\begin{matrix}{\dot{V}}_{θ} = ζ \dot{ζ} = ζ ( {\ddot{e}}_{θ} + λ {\dot{e}}_{θ} ) \\ = ζ [ \frac{1}{r} [ - 2 \dot{r} \dot{θ} + {υ}_{l} {ω}_{l} cos {σ}_{l} - {υ}_{f} {ω}_{f} cos {σ}_{f} + Δ ) + λ \dot{θ} ] \\ = ζ [ ( λ - \frac{2 \dot{r}}{r} ) \dot{θ} + \frac{{υ}_{l} {ω}_{l} cos {σ}_{l}}{r} - \frac{{υ}_{f} cos {σ}_{f}}{r} {ω}_{f} + \frac{Δ}{r} ] .\end{matrix} \qquad ( 29 )$$

Using Theorem 1, may be rewritten as

$${\dot{V}}_{θ} = ζ ( \frac{Δ}{r} - \frac{{v}_{f} cos ( {γ}_{f} - θ )}{r} {ω}_{f} + λ {\dot{e}}_{θ} ) \\ {\dot{V}}_{θ} = ζ [ ( λ - \frac{2 \dot{r}}{r} ) \dot{θ} + \frac{{υ}_{l} {ω}_{l} cos {σ}_{l}}{r} - ( \frac{{υ}_{l} cos {σ}_{l} + {K}_{r} sign ( {e}_{r} )}{r} ) {ω}_{f} + \frac{Δ}{r} ] \qquad ( 30 )$$

Via substituting the angular speed control given in (26), the above expression reduces to

$${\dot{V}}_{θ} = ζ ( \frac{Δ}{r} - \frac{ηsign ( ζ ) + {K}_{θ} ζ}{r} + λ {\dot{e}}_{θ} ) \\ {\dot{V}}_{θ} = ζ ( - {K}_{θ} sign ( ζ ) + \frac{Δ}{r} ) \leq - ( {K}_{θ} - \frac{η}{r} ) \vert ζ \vert , \qquad ( 31 )$$

which yields a sufficient condition on K_{θ} as presented in (28) to ensure V_{θ}<0 ∀ζ∈R\{0}. Thus, ζ will eventually go to zero within a finite time |ζ(0)|/K_{θ}, after which e_{θ}+λ_{eθ}=0, implying that e_{θ} will decay as e_{θ}(t)=e_{θ}(0) exp{−λt} to ensure that the follower maintains a fixed line-of-sight angle θ_{d}. This completes the proof.

Remark 3. The follower's bearing angle dynamics can be expressed as

$${\dot{σ}}_{f} = \frac{{v}_{l} sin ( {γ}_{l} - θ ) - {v}_{f} sin ( {γ}_{f} - θ )}{r cos {σ}_{f}} - \frac{{v}_{f} cos ( {γ}_{f} - θ )}{r cos {σ}_{f}} {ω}_{f} \qquad ( 32 )$$

$${\dot{σ}}_{f} = \frac{r [ ( λ - \frac{2 \dot{r}}{r} ) \dot{θ} ] + {v}_{l} {ω}_{l} cos {σ}_{l}}{{v}_{l} cos {σ}_{l}} - \dot{θ}$$

when ζ→0 and eᵣ→0. After ζ→0, θ→θ_{d} and θ→0. Imposing this in the above relation leads to

$${\dot{σ}}_{f} = \frac{{v}_{l} sin ( {γ}_{l} - {θ}_{d} ) - {v}_{f} sin ( {γ}_{f} - {θ}_{d} )}{r cos {σ}_{f}} \qquad ( 33 )$$

$${\dot{σ}}_{f} = {ω}_{l} ,$$

which implies that ω_{f}→ωₗ and σ_{f}→σₗ. For a fixed line-of-sight angle θ_{d}, this eventually means that γ_{f}→γₗ. Therefore, it can be inferred that the follower ultimately matches the orientation and speed of the leader to maintain formation. Also, this essentially points to the fact that the proposed control law will become unbounded if the leader's control is unbounded. Such a situation may not arise practically because the control authority in any vehicle is limited. In the event σₗ→π/2 before θ→0, then the control authority of the follower will saturate briefly until the necessary error variables have vanished.

For a heterogeneous leader driven by uₗ=aₗ,

$${\text{?}}_{θ} = \frac{{v}_{l} sin ( {γ}_{l} - θ ) - {v}_{f} sin ( {γ}_{f} - θ )}{r} + \frac{{a}_{l} cos ( {γ}_{l} - θ ) - {v}_{f} {ω}_{f} cos ( {γ}_{f} - θ )}{r} \qquad ( 34 )$$

$${\text{?}}_{θ} = \frac{1}{r} [ - 2 \dot{r} \dot{θ} + {a}_{l} cos {σ}_{l} - {v}_{f} {ω}_{f} cos {σ}_{f} + Δ ] ,$$

$$\text{?} \text{indicates text missing or illegible when filed}$$

for which the follower's angular speed control is

$${ω}_{f} = \frac{sign ( cos ( {γ}_{f} - θ ) )}{{v}_{f} cos ( {γ}_{f} - θ )} [ ηsign ( ζ ) + {K}_{θ} ζ ] \qquad ( 35 )$$

$${ω}_{f} = \frac{r [ ( λ - \frac{2 \dot{r}}{r} ) \dot{θ} + {K}_{θ} sign ( ζ ) ] + {a}_{l} cos {σ}_{l}}{{v}_{l} cos {σ}_{l} + {K}_{r} sign ( {e}_{r} )} .$$

It follows from the previous discussion on the bearing angle dynamics that for a heterogeneous leader steered by lateral acceleration that the steady-state bearing angle dynamics will be σ_{f}=aₗ/vₗ, which implies that ω_{f}→aₗ/vₗ. Note that in FLFM, the follower is able to change its position on the ring, thereby allowing it some flexibility during formation.

FBFM. In the FBFM scheme, the goal is to drive the follower's bearing angle to the desired value σ_{fd}. To this end, consider the error variable,

$${e}_{σ} = {σ}_{f} - {σ}_{{f}_{d}} , \qquad ( 36 )$$

Where

$${σ}_{{f}_{d}} ∈ [ - \frac{π}{2} + δ , \frac{π}{2} - δ ] and δ ∈ ( 0 , \frac{π}{2} ] \text{?}$$

$$\text{?} \text{indicates text missing or illegible when filed}$$

is a parameter chosen to avoid any potential singular points. We now propose the follower's angular speed control as

$${ω}_{f} = \frac{{v}_{l} sin {σ}_{l} - {v}_{f} sin {σ}_{f}}{r cos {σ}_{f}} + \frac{{K}_{σ} sign ( {e}_{σ} )}{cos {σ}_{f}} \qquad ( 37 )$$

$${ω}_{f} = \frac{{v}_{l} ( sin {σ}_{l} - cos {σ}_{l} tan {σ}_{f} )}{r} + \frac{{K}_{r} sign ( {e}_{r} ) tan {σ}_{f}}{r} - \frac{{K}_{σ}}{{b}^{2} - {e}_{σ}^{2}} {e}_{σ} ,$$

where b is a parameter that restricts the error (36) in the domain (−b, b). Note that in order to allow flexibility in the follower's motion and to avoid potential singular points, it has to operate under certain constraints with a prescribed accuracy. The concept of the Barrier Lyapunov Function is one such method where a controller is designed under state constraints to guarantee the boundedness of the related error variable.

Barrier Lyapunov Function Definition. A Barrier Lyapunov Function is a scalar function denoted as V (x), which is defined on an open region D containing the origin of the system and having continuous first-order partial derivatives that satisfy the following three properties,
(1) V(x)>0 ∀x∈D and V(x)→0 as x→0,
(2) V(x)→∞ as x→∂D, where ∂D denotes the boundary of region D, and
(3) V(x(t))≤β∀t≥0, along the solution of the system x=f(x), where x(0)∈D and β is a positive constant.

Theorem 2. Consider the leader-follower motion kinematics given in 2D. The follower's angular speed control law ensures that the follower's bearing angle, σ_{f}, converges to the desired value, σ_{fd}, regardless of the leader's turn rate or acceleration.

Proof. Following the concept of the Barrier Lyapunov Function, the function

$${V}_{σ} = \frac{1}{2} log ( \frac{{b}^{2}}{{b}^{2} - {e}_{σ}^{2}} ) \qquad ( 38 )$$

shows that the controller proposed in (37) restricts the error (36) in the domain (−b, b). On differentiating V_{σ} with respect to time, one may obtain

$${\dot{V}}_{σ} = \frac{{e}_{σ} {\dot{e}}_{σ}}{{b}^{2} - {e}_{σ}^{2}} , \qquad ( 39 )$$

which can be expressed as

$${\dot{V}}_{σ} = \frac{{e}_{σ}}{{b}^{2} - {e}_{σ}^{2}} ( \frac{{v}_{l} sin {σ}_{l} - {v}_{f} sin {σ}_{f}}{r cos {σ}_{f}} - \frac{{v}_{f} cos ( {γ}_{f} - θ )}{r cos {σ}_{f}} {ω}_{f} ) \qquad ( 40 )$$

$${\dot{V}}_{σ} = \frac{{e}_{σ}}{{b}^{2} - {e}_{σ}^{2}} ( {\dot{σ}}_{f} ) = \frac{{e}_{σ}}{{b}^{2} - {e}_{σ}^{2}} ( {\dot{γ}}_{f} - \dot{θ} ) ,$$

after taking the time derivative. On further simplification using 2D kinematics, one has

$${\dot{V}}_{σ} = \frac{{e}_{σ}}{{b}^{2} - {e}_{σ}^{2}} ( \frac{{v}_{l} sin {σ}_{l} - {v}_{f} sin {σ}_{f}}{r cos {σ}_{f}} - \frac{{v}_{f} cos ( {γ}_{f} - θ )}{r cos {σ}_{f}} {ω}_{f} ) \qquad ( 41 )$$

$${\dot{V}}_{σ} = \frac{{e}_{σ}}{{b}^{2} - {e}_{σ}^{2}} ( {ω}_{f} - \frac{{v}_{l} sin {σ}_{l} - {v}_{f} sin {σ}_{f}}{r} ) ,$$

which can also be written as

$${\dot{V}}_{σ} = \frac{{e}_{σ}}{{b}^{2} - {e}_{σ}^{2}} ( \frac{{v}_{l} sin {σ}_{l} - {v}_{f} sin {σ}_{f}}{r cos {σ}_{f}} - {ω}_{f} ) \qquad ( 42 )$$

$${\dot{V}}_{σ} = \frac{{e}_{σ}}{{b}^{2} - {e}_{σ}^{2}} [ {ω}_{f} - \frac{{v}_{l} ( sin {σ}_{l} - cos {σ}_{l} tan {σ}_{f} )}{r} - \frac{{K}_{r} sign ( {e}_{r} ) tan {σ}_{f}}{r} ] ,$$

if we use the results in Theorem 1 to substitute for v_{f}. It follows from the above expression that the proposed angular speed control renders ^{⋅}V_{σ} as

$${\dot{V}}_{σ} = - \frac{{K}_{σ} {e}_{σ}^{2}}{{b}^{2} - {e}_{σ}^{2}} \qquad ( 43 )$$

$${\dot{V}}_{σ} = - \frac{{K}_{σ} {e}_{σ}^{2}}{{b}^{2} - {e}_{σ}^{2}} < 0 , ∀ {e}_{σ} ∈ ( - b , b ) \backslash \{ 0 \}$$

if K_{σ}>0, thereby ascertaining that the error (36) remains within the interval (−b, b). Eventually, the follower's bearing angle settles at the desired value to keep it in formation with the leader. This completes the proof.

Remark 4. A suitable choice of δ can ensure that the proposed angular speed control remains finite by avoiding σ_{f}∈{0,π/2}

$${e}_{σ}^{2} \to {b}^{2} .$$

Hence, the proposed control is nonsingular in the domain of operation.

Remark 5. Unlike other formation schemes, knowledge of the leader's angular speed or lateral acceleration is not required, which may come across as an appealing feature given that it is difficult to obtain such information.

It is also worth noting that since σ_{f} does not necessarily become equal to σₗ, there might be instances during formation when v_{f}≠vₗ even though eᵣ→0. As a matter of fact, when σ_{f}→σ_{fd}, one has r=vₗ cos σₗ−v_{f} cos σ_{fd}. Suppose the follower has reached a point on the ring, where r=0 since r→r_{d}. Therefore, it follows that vₗ cos σₗ−v_{f} cos σ_{fd}=0, which implies that v_{f}=c vₗ cos σₗ, where c=1/cos σ_{fd} is a constant value. This essentially means that the follower's speed control may have a sinusoidal behavior during formation whose amplitude is decided by c vₗ, and frequency is governed by the behavior of σₗ. Furthermore, it is inferred that when eᵣ→0, that is, when the follower is on the ring, v_{f} is not necessarily equal to vₗ, meaning that the follower can change its position on the ring while maintaining a fixed relative distance with respect to the leader. This is in contrast with HAFM and FLFM where v_{f}→vₗ during formation. Consequently, the proposed FBFM is more flexible and introduces an anticipatory behavior in the follower's motion. As the follower always stays on the ring, it is also guaranteed that it never collides with the leader since r=r_{d}, which is strictly greater than zero.

Remark 6. A proper selection of parameters b and δ could ensure that the proposed flexible-geometry formation scheme (FBFM) emulates a human pilot's behavior in aerial combat, dogfights, or other leader-wingman-type situations. This is possible since the notion of being behind the leader can be enforced using b and δ, and Assumption 2 might be relaxed in FBFM. During formation, |e_{σ}|<b implies that either

$$b + {σ}_{{f}_{d}} = \frac{π}{2} - δ or - b + {σ}_{{f}_{d}} = - \frac{π}{2} + δ$$

at the extreme cases. If

$$\vert {σ}_{{f}_{d}} \vert < \frac{π}{2} ,$$

then it ensures that

$$\vert {σ}_{i} \vert < \frac{π}{2}$$

and thus the follower will always stay behind the leader.

Further, it follows that, at steady state,

$$\begin{matrix}{σ}_{f} = 0 ⇒ {ω}_{f} = \frac{{v}_{l} sin {σ}_{l} - {v}_{f} sin {σ}_{{f}_{d}}}{r cos {σ}_{{f}_{d}}} \\ {ω}_{f} \to \frac{{v}_{l} ( sin {σ}_{l} - cos {σ}_{l} tan {σ}_{{f}_{d}} )}{{r}_{d}}\end{matrix} \qquad ( 44 )$$

This implies |v_{f}|≤c|vₗ| and

$${ω}_{f} \leq \vert \frac{\text{?}}{\text{?}} \vert$$

$$\text{?} \text{indicates text missing or illegible when filed}$$

at steady state for σₗ∈(−π/2, π/2). Therefore, both the v_{f} and ω_{f} are bounded at the steady state since the speed of the leader is bounded as in Assumption 1. However, during the transient phase, the values of the control inputs may exceed these bounds or the maximum allowable magnitude of follower's control inputs due to the error terms in the proposed control law. This will result in the saturation of the control inputs briefly until the control input expressions yield values within the allowable bounds.

CBFM. In the CBFM scheme, the goal is to ensure the follower's bearing angle of remains within predefined bounds a<σ_{f}<b, where 0≤a<b≤π/2, while maintaining r→r_{d}. The bearing angle error is defined as:

$${e}_{σ} = {σ}_{f} - {σ}_{fd}$$

where σ_{fd} ∈[δ,π/2−δ], and the error is constrained as:

$$- c < {e}_{σ} < d$$

with c=σ_{fd}−a, d=b−σ_{fd}. The follower's angular speed control inputs in 3D are designed to minimize the control effort, defined by the cost function:

$$J = \sqrt{\frac{{ω}_{{γ}_{f}}^{2}}{{w}_{1}^{2}} + \frac{{ω}_{{χ}_{f}}^{2}}{{w}_{2}^{2}}}$$

where w₁, w₂>0 are weighting parameters. The effective angular control input U_{f} is:

$${U}_{f} = - ( \frac{cos {γ}_{f} sin θ cos ( {χ}_{f} - ψ ) - sin {γ}_{f} cos θ}{sin {σ}_{f}} θ - \frac{cos {γ}_{f} cos θ sin ( {χ}_{f} - ψ )}{sin {σ}_{f}} ) - ( \frac{q ( {e}_{σ} )}{{c}^{2} - {e}_{σ}^{2}} + \frac{1 - q ( {e}_{σ} )}{{d}^{2} - {e}_{σ}^{2}} ) {K}_{σ} {e}_{σ}$$

where q(e_{σ})=1 if e_{σ}>0, else (O), and K_{σ}>0. The pitch and yaw angular speeds are:

$${ω}_{{γ}_{f}} = \frac{( sin {γ}_{f} cos θ ( {χ}_{f} - ψ ) - cos {γ}_{f} sin θ ) / {w}_{1}^{2}}{{( sin {γ}_{f} cos θ cos ( {χ}_{f} - ψ ) - cos {γ}_{f} sin θ )}^{2} / {w}_{1}^{2} + {( cos θ sin ( {χ}_{f} - ψ ) )}^{2} / {w}_{2}^{2}} {U}_{f} sin {σ}_{f}$$

$${ω}_{{χ}_{f}} = \frac{cos θ sin ( {χ}_{f} - ψ ) / {w}_{2}^{2}}{{( sin {γ}_{f} cos θ cos ( {χ}_{f} - ψ ) - cos {γ}_{f} sin θ )}^{2} / {w}_{1}^{2} + {( cos θ sin ( {χ}_{f} - ψ ) )}^{2} / {w}_{2}^{2}} {U}_{f} sin {σ}_{f}$$

Theorem 3. The follower's angular speed control inputs ensure that σ_{f}→σ_{fd} while remaining within ((a,b)), guaranteeing convergence to the desired position set ζ without requiring the leader's angular speeds.

Proof. Consider the asymmetric Barrier Lyapunov Function:

$${V}_{σ} = \frac{q}{2} log ( \frac{{c}^{2}}{{c}^{2} - {e}_{σ}^{2}} ) + \frac{1 - q}{2} log ( \frac{{d}^{2}}{{d}^{2} - {e}_{σ}^{2}} )$$

Differentiating yields:

$$( \frac{q}{{c}^{2} - {e}_{σ}^{2}} + \frac{1 - q}{{d}^{2} - {e}_{σ}^{2}} ) {e}_{σ} {é}_{σ}$$

Substituting the 3D bearing angle dynamics and U_{f}, we get:

$${V}_{σ} = - {K}_{σ} ( \frac{q}{{c}^{2} - {e}_{σ}^{2}} + \frac{1 - q}{{d}^{2} - {e}_{σ}^{2}} ) {e}_{σ}^{2} < 0$$

for e_{σ}∈(−c,d)\{0\}, ensuring e_{σ} remains bounded and converges to zero, so ø_{f}→σ_{fd} within ((a,b)). The optimization of ω_{γf} and ω_{χf} minimizes (J), as the Hessian of (J) is positive definite.

Remark 7. The CBFM scheme allows the follower to converge to any point on a partial hemispherical shell, defined by r=r_{d} and of σ_{f}∈(a,b), providing greater flexibility than FBFM, which converges to a single ring. This enables anticipatory maneuvers in 3D, emulating human pilot behavior in air-to-air combat.

Simulations of the various formation schemes show the efficacy of the proposed FBFM and CBFM over other schemes. In the subsequent results, the leader is initially located at [xₗ yₗ]=[0 0]^{T} and has a heading angle, γₗ=10°. The follower starts at [xₗ yₗ]=[0-500]^{T} m with a heading angle, γₗ=90° or [x_{f}, y_{f}, z_{f}]=[0,0,800]^{T}m with y_{f}=10°, x_{f}=30°, and executes the proposed control laws. The follower's desired proximity from the leader is chosen as r_{d}=100 m. In the trajectory plots that follow, hollow circular markers represent the initial positions of the vehicles. The bounds on the follower's linear and angular velocities are vᵢ=0, vᵢ=40 m/sec, and ωₘ=1 rad/sec, and in 3D |ω_{fd}}, |ω_{χf}}|<1 rad/sec. The controller gains are Kᵣ=10, K_{γ1}=0.25, K_{γ2}=0.25, K_{θ}=10, λ=0.5 and K_{σ}=0.5.

For simulation of the performance of HAFM for homogeneous and heterogeneous leader maneuvering arbitrarily, the linear speed of the leader is

$${γ}_{l} = 20 + 5 sin ( \frac{π1}{10} )$$

and its angular speed is

$${ω}_{l} = \frac{1}{20} sin ( \frac{π1}{20} ) ,$$

when it is homogeneous. For the first heterogeneous case, the leader is controlled using only angular speed given by

$${ω}_{l} = \frac{1}{40} sin ( \frac{π1}{20} ) ,$$

while for the second heterogeneous case, the leader executes the maneuver using lateral acceleration given by

$${a}_{l} = \frac{1}{50} sin ( \frac{π l}{20} ) .$$

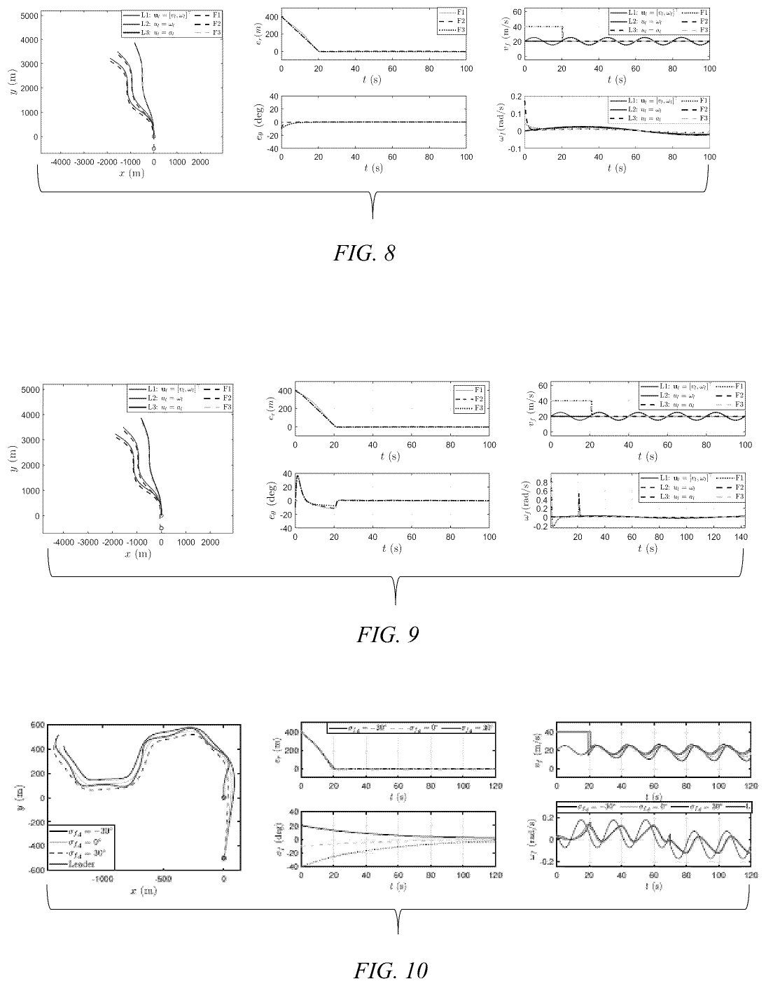

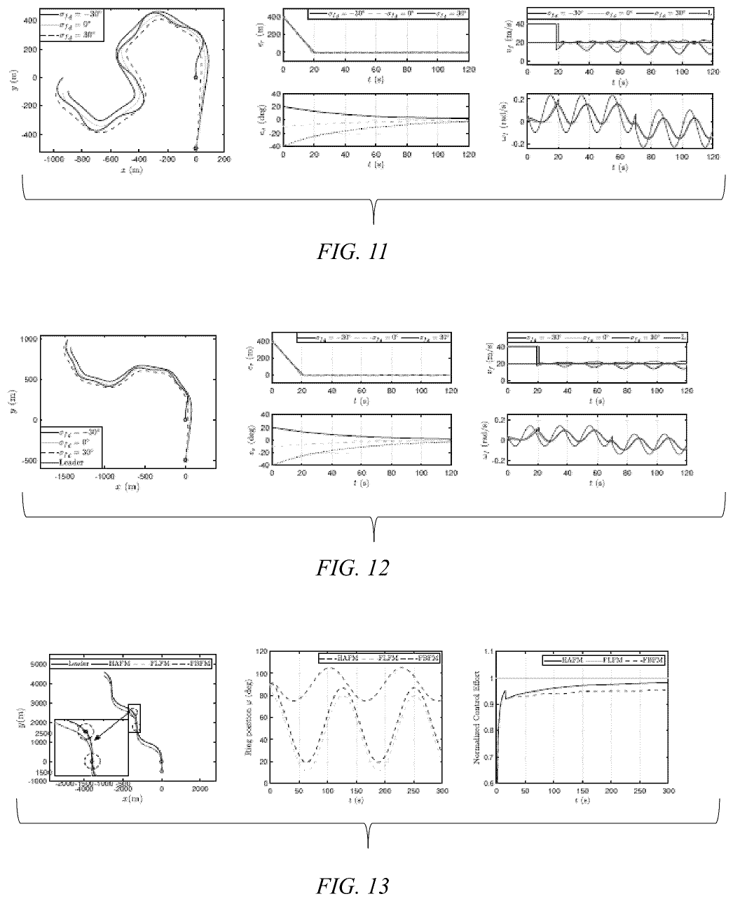

The leader travels at a constant speed of 20 m/s for both heterogeneous cases. FIG. 8 represents a scenario where the follower maintains the same heading angle as that of the leader to keep formation in all the cases. The follower converges on the desired ring around the leader since the error in the desired range vanishes around 20 s. However, even before the follower has reached the ring, it matches its heading angle with that of the leader. After all the errors converge to zero, the follower mimics the leader's control input. While the leader takes a different trajectory, the performance of the follower in HAFM is similar in each case. However, we notice that the follower requires less control effort to maintain formation when the leader is homogeneous.

The performance of the FLFM scheme is simulated and analyzed for different classes of leader vehicles. The desired line-of-sight angle is chosen as θ_{d}=80°. The leader's control inputs in various cases are taken the same as in the previous maneuvering scheme. FIG. 9 depicts the performance of the FLFM scheme where the follower maintains the desired line-of-sight angle and remains at the desired proximity of the leader. It is observed that the line-of-sight error converges only after the range error has converged, which means that the follower first converges on the ring and then adjusts the desired line-of-sight angle to keep formation. Since the control objective is to maintain a fixed line-of-sight angle, the follower can have a different heading angle from the leader, thereby introducing some flexibility during the formation maneuver. We also observe that the follower's control inputs match the leader's control inputs during formation.

For FBFM, the followers' behavior is analyzed for different values of the desired bearing angle (σ_{fd}=−30°, 0°, 30°). FIG. 10 depicts a scenario when the leader is homogeneous and executes a linear speed, vₗ⊂20+5 sin(πt/10) and an angular speed as

$${ω}_{l} = \frac{\dot{sign} ( t - 70 )}{40} ( 2 - 5 sin ( \frac{π t}{10} ) )$$

to maneuver aggressively. The results in FIGS. 9 and 10 consider a heterogeneous leader steered using

$${ω}_{l} = \frac{sign ( t - 70 )}{30} ( 2 - 5 sin ( \frac{π t}{10} ) ) and {a}_{l} = \frac{sign ( t - 70 )}{2} ( 2 - 5 sin ( \frac{π t}{10} ) )$$

respectively, while maintaining a constant linear speed of 20 m/s. FIGS. 8-10 show that the follower remains at fixed proximity behind the leader even when the leader turns aggressively. It is also observed from FIGS. 8-10 that regardless of σ_{fd}, the follower converges on the ring of radius r_{d}. Based on the leader's turn in the counterclockwise/clockwise sense, the follower anticipates and takes appropriate turns by varying its turn rate in each case. The range error also converges to zero within 20 s, which is earlier than the estimated settling time of 40 s based on the initial conditions.

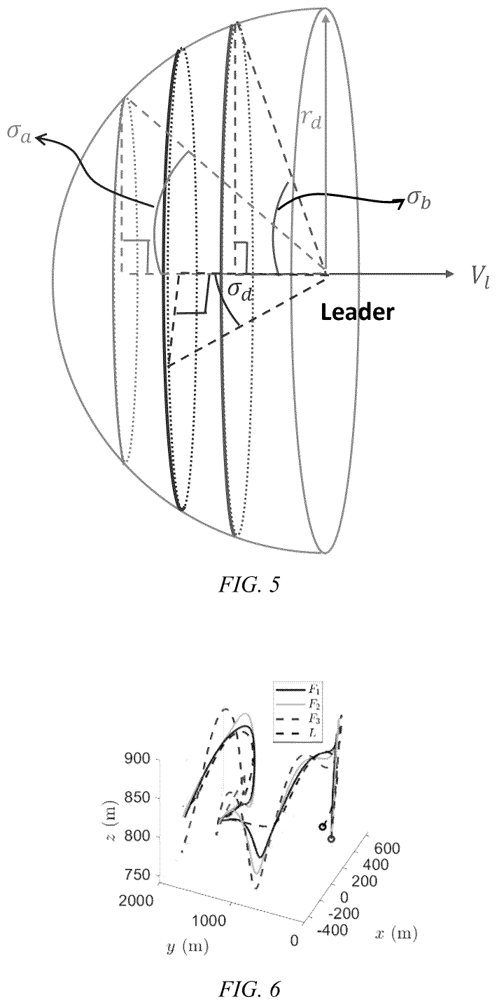

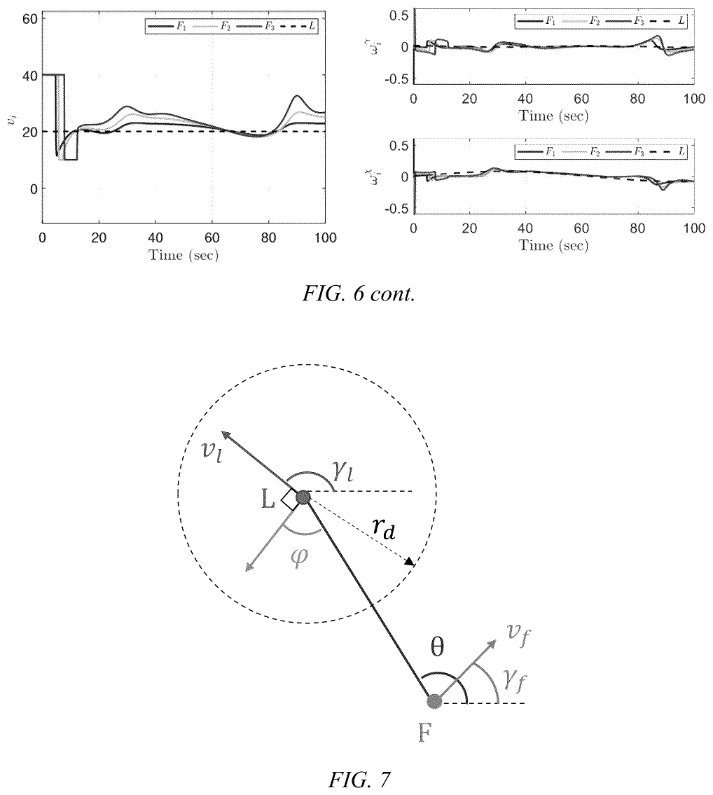

For CBFM, the follower's behavior is analyzed for different desired bearing angles (σ_{fd}=30°, 45°, 60°) with bounds a=0, b=π/2. FIG. 5 depicts the performance for leader maneuvers including straight-line motion (SM), weaving maneuver (WM) with ω_{γl}=sin(t/5)/20, ω_{χl}=sin(t/10)/10, and lazy-8 maneuver (L8M) with ω_{γl}=sin(t/10)/100, ω_{χl}=sin(t/20)/12, all at vₗ=20 m/s. The follower converges to the sphere of radius r_{d}=100 m and maintains σ_{f} within ((a,b)), adjusting its position on the partial hemispherical shell to anticipate the leader's motion, as shown in FIG. 5.

As shown in FIG. 13, the comparison of the different relational maneuvering schemes shows that the FBFM and CBFM scheme offers the most flexibility during formation regardless of the leader's aggressive turns. In this case, we let the desired proximity from the leader as r_{d}=200 m (a larger ring compared to the previous cases) and choose the leader's linear and angular speed as vₗ=20 sin(t/10)+30, ωₗ=sin(t/10)/10

$${ω}_{l} = \frac{1}{30} sin ( \frac{π}{20} ) , \qquad {υ}_{l} = 20 m / s .$$

For FLFM, the desired line-of-sight angle is selected as θ_{d}=80°, while, for FBFM, the desired bearing angle is selected as σ_{fd}=0°. For CBFM, σ_{fd}=45° with a=0, b=π/2. The follower's objective in HAFM is to match the leader's heading angle, which is initially chosen as γ_{f}=90°. It is observed that the follower remains at different positions on the ring or hemispherical shell around the leader at different instances in time to maintain formation. Since the follower constantly maneuvers to be in formation, its ring angle, φ, is not fixed. The follower's ring angle profiles, as seen in FIG. 13, evidence that φ changes less frequently in FBFM and CBFM than HAFM and FLFM. This indicates that for an aggressive maneuver of the leader, the follower executes maneuvers accordingly to anticipate any aggressive turns. The follower's responsive maneuvers change the line-of-sight angle in such a manner that φ changes less frequently. In other words, slow variation in φ implies that the follower has acquired a tactically advantageous position, resulting in anticipatory maneuvers to maintain formation. This is also exhibited in human pilots during lead/lag pursuit. In the case of HAFM and FLFM, the formation is also flexible, but the degree of flexibility may be less than that in FBFM and CBFM since aggressive turns in the leader's trajectory necessitate the follower to maneuver more. Although φ shows larger variations in the case of HAFM and FLFM, it provides a lesser tactical advantage than FBFM because the follower has to execute larger maneuvers to stay in formation and may consume more energy. The total accumulated normalized control effort for the follower can be computed as

$${\int }_{0}^{t} {( \frac{{υ}_{f}}{{\overline{υ}}_{f}} )}^{2} + {( \frac{{ω}_{f}}{{ω}_{m}} )}^{2} dt .$$

Note that the contribution of the linear speed in the overall control effort is much larger than the angular speed, leading to the total effort mostly due to the variation in v_{f}. FIG. 13 also shows the comparison of accumulated control effort for different flexible formation maneuvers, normalized using the accumulated control effort for the FLFM scheme. It is evident that the FBFM and CBFM scheme requires the least control effort compared to other maneuvering schemes while still providing the most flexibility during formation.

In order to verify the effectiveness of the suggested flexible formation scheme, namely the FBFM and CBFM, we carry out both Software-in-the-Loop simulations and implement the proposed laws on actual aircraft. It is also worth noting that the proposed design offers a degree of robustness during flight tests because we do not explicitly account for any aerodynamic parameter variations during the design. Such features also allow for simple and elegant design procedures and provide insights into the motion of the vehicles during formation.

Experiments were conducted on the FVR-90, a fixed-wing vertical take-off and landing vehicle developed by L3Harris technologies. The experimental setup was extended to include 3D maneuvers using a combination of fixed-wing and quadrotor UAVs to validate the proposed 2D and 3D formation control schemes, including HAFM, FLFM, FBFM, and CBFM.

Experimental Setup. The experiments utilized two UAVs: a fixed-wing FVR-90 as the leader and a quadrotor UAV as the follower, equipped with onboard sensors (radar, lidar, and vision-based systems) for relative measurements in GPS-denied environments. The leader followed predefined trajectories, including straight-line motion, circular paths in 2D, and complex 3D maneuvers such as weaving and lazy-8 patterns. The follower's control system implemented the proposed control laws for linear speed (v_{f}) and angular speeds (ω_{f} in 2D, or ω_{γf},ω_{χf} in 3D), as described in above for CBFM and earlier sections for HAFM, FLFM, and FBFM. The desired relative distance was set to r_{d}=100 m, with controller gains Kᵣ=10, K_{γ1}=0.25, K_{γ2}=0.25, K_{θ}=10, λ=0.5, and K_{σ}=0.5. For CBFM, the bearing angle bounds were set as a=0, b=π/2, with desired bearing angles σ_{fd}={30°, 45°, 60° }. The experiments were conducted in a controlled outdoor environment with wind disturbances to test robustness.

Experimental Results. The results demonstrated that the follower successfully maintained the desired relative distance r_{d} across all maneuvers. In 2D, the HAFM scheme ensured the follower's heading angle matched the leader's within 10 seconds, as shown in FIG. 8. The FLFM scheme maintained a fixed line-of-sight angle (θ_{d}=80°) with convergence after the range error reached zero, as depicted in FIG. 9. The FBFM scheme allowed the follower to maintain a fixed bearing angle (σ_{fd}={−30°, 0°, 30°}) with anticipatory maneuvers, as shown in FIGS. 8-10. In 3D, the CBFM scheme enabled the follower to converge to a partial hemispherical shell around the leader, maintaining σ_{f}∈(0, π/2) and adapting to the leader's weaving and lazy-8 maneuvers, as shown in FIG. 5. The follower's position remained within the set ζ={Φ∈R²|r=r_{d}, σ_{f}∈(0,π/2)}, demonstrating flexibility and robustness. The control effort, measured as the integral of in

$${v}_{f}^{2} + {ω}_{f}^{2}$$

### 2D or

$${v}_{f}^{2} + {ω}_{γ f}^{2} + {ω}_{χ f}^{2}$$

in 3D, was lowest for FBFM and CBFM, confirming their energy efficiency, as shown in FIG. 13.

Robustness and Practical Considerations. The proposed control laws were robust to wind disturbances and measurement noise, as the follower relied solely on relative measurements (range, line-of-sight angles, and bearing angles) without requiring leader state information. In 3D, the CBFM scheme handled complex leader maneuvers without singularities, as the bearing angle constraints a<σ_{f}<b avoided extreme values (σ_{f}={0,π/2}). The use of Barrier Lyapunov Functions ensured that errors remained within bounded domains, enhancing safety in close-proximity formations. The experiments validated the applicability of the proposed schemes in GPS-denied environments, making them suitable for tactical missions, urban air mobility, and swarm operations in both 2D and 3D contexts.

Conclusion. The proposed flexible formation control schemes (HAFM, FLFM, FBFM, and CBFM) emulate human pilot behavior by allowing the follower to adapt its position and orientation dynamically. Unlike rigid formation control, these schemes enable anticipatory maneuvers, reducing control effort and enhancing robustness. The extension to 3D via CBFM provides greater flexibility by allowing the follower to converge to a partial hemispherical shell, making it ideal for complex 3D missions such as air-to-air combat and reconnaissance. The simulation and experimental results confirm the efficacy and practicality of the proposed methods.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value. For example, “about” in the context of relative distance measurements refers to a tolerance of ±5% of the nominal value, as determined by onboard sensor accuracy.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a chemical composition and/or method that “comprises” a list of elements (e.g., components or features or steps) is not necessarily limited to only those elements (or components or features or steps), but may include other elements (or components or features or steps) not expressly listed or inherent to the chemical composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a chemical composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

1. A computer-implemented method for controlling a follower unmanned aerial vehicle (UAV) in a flexible formation with a leader UAV, comprising:
(a) determining a relative distance (r) between the follower UAV and the leader UAV based on relative measurements obtained from onboard sensors;
(b) calculating a range error (eᵣ=r−r_{d}), where (r_{d}) is a desired fixed distance;
(c) computing a linear speed control input (v_{f}=vₗ cos σₗ+Kᵣ sin(eᵣ)) for the follower UAV, where (vₗ) is the leader's linear speed, (σₗ) is the leader's bearing angle, and (Kᵣ) is a positive controller gain;
(d) determining a bearing angle error (e_{σ}=σ_{f}−σ_{fd}), where (σ_{f}) is the follower's bearing angle and σ_{fd} is a desired bearing angle;
(e) computing an angular speed control input for the follower UAV using the following:
$${ω}_{f} = \frac{{v}_{l} ( sin {σ}_{l} - cos {σ}_{l} tan {σ}_{f} )}{r} + \frac{{K}_{r} sign ( {e}_{r} ) tan {σ}_{f}}{r} - \frac{{K}_{σ}}{{b}^{2} - {e}_{σ}^{2}} {e}_{σ} ,$$
where K_{σ} is a positive controller gain and (b) is a parameter defining an error bound; and
(f) applying the linear speed control input (v_{f}) and angular speed control input (ω_{f}) to maintain the follower UAV at the desired distance (r_{d}) while allowing flexible positioning relative to the leader UAV.

2. The computer-implemented method of claim 1, wherein the follower UAV maintains a fixed-bearing angle formation maneuver (FBFM) by converging (σ_{f}) to (σ_{fd}), independent of the leader's angular speed or lateral acceleration.

3. The computer-implemented method of claim 1, wherein the relative measurements are obtained without vehicle-to-vehicle communication, enabling operation in GPS-denied or communication-degraded environments.

4. The computer-implemented method of claim 1, wherein determining the relative distance (r) and the bearing angle comprises using a sensor module selected from the group consisting of a radar, lidar, or vision-based sensor for measuring relative distance and bearing angle.

5. A computer-implemented system for flexible formation control of a follower unmanned aerial vehicle (UAV) relative to a leader UAV, comprising:
(a) a sensor module configured to measure a relative distance (r) and a bearing angle σ_{f} of the follower UAV relative to the leader UAV;
(b) a processor configured to:
(i) compute a range error eᵣ=r−r_{d}, where r_{d} is a desired fixed distance;
(ii) determine a linear speed control input v_{f} and an angular speed control input ω_{f} based on the range error and a bearing angle error;
(iii) execute a fixed-bearing angle formation maneuver (FBFM) to maintain the follower UAV at the desired distance r_{d} with a desired bearing angle ω_{fd}; and
(c) a control module configured to apply the linear and angular speed control inputs to the follower UAV.

6. The computer-implemented system of claim 4, wherein the sensor module includes technology selected from the group consisting of a radar, lidar, or vision-based sensor for measuring relative distance and bearing angle.

7. The computer-implemented system of claim 4, wherein determining an angular speed control input comprises computing an angular speed control input for the follower UAV using the following:
$${ω}_{f} = \frac{{v}_{l} ( sin {σ}_{l} - cos {σ}_{l} tan {σ}_{f} )}{r} + \frac{{K}_{r} sign ( {e}_{r} ) tan {σ}_{f}}{r} - \frac{{K}_{σ}}{{b}^{2} - {e}_{σ}^{2}} {e}_{σ} ,$$
where K_{σ} is a positive controller gain and (b) is a parameter defining an error bound.

8.-11. (canceled)

12. A method for controlling a formation of a leader-follower unmanned aerial vehicle (UAV) system, comprising:
(a) determining a relative distance ((r)) between a leader UAV and a follower UAV in two-dimensional (2D) or three-dimensional (3D) space;
(b) measuring a line-of-sight angle (θ) and, in 3D, an azimuth angle (φ) between the leader UAV and the follower UAV;
(c) measuring a bearing angle (σ_{f}) of the follower UAV relative to the line-of-sight;
(d) computing a range error (eᵣ=r−r_{d}) based on a desired relative distance (r_{d});
(e) controlling the follower UAV's linear speed (v_{f}) to drive the range error to zero within a finite time;
(f) controlling the follower UAV's angular speed (ω_{f}) in 2D, or pitch and yaw angular speeds (ω_{γf}, ω_{χf}) in 3D, to achieve a desired formation maneuver selected from the group consisting of:
(i) a Heading-Alignment Formation Maneuver (HAFM) to align the follower's heading angle (γ_{f}) with the leader's heading angle (γₗ);
(ii) a Fixed Line-of-Sight Formation Maneuver (FLFM) to maintain a fixed line-of-sight angle (θ_{d});
(iii) a Fixed-Bearing Angle Formation Maneuver (FBFM) to maintain a fixed bearing angle (σ_{fd});
(iv) a Constrained-Bearing Angle Formation Maneuver (CBFM) to constrain the bearing angle (σ_{f}) within predefined bounds (a<σ_{f}<b) in 3D, converging to a partial hemispherical shell;
wherein the follower UAV uses only relative measurements without requiring the leader's angular speed or lateral acceleration.

13. The method of claim 12, wherein controlling the follower UAV's linear speed (v_{f}) comprises:
(a) computing v_{f}=vₗ cos σₗ+Kᵣ sign(eᵣ) for 2D maneuvers, where vₗ is the leader's linear speed, σₗ is the leader's bearing angle, and Kᵣ>0 is a controller gain;
(b) computing
$${v}_{f} = \frac{{v}_{l} ( sin θ sin {y}_{l} + cos θ cos {y}_{l} cos ( ψ - {χ}_{f} ) ) + {K}_{γ} sign ( {s}_{γ} )}{sin θ sin {γ}_{f} + cos θ cos {y}_{f} cos ( ψ - {χ}_{f} )}$$
are the leader's flight path and heading angles, and γ_{f}, χ_{f} are the follower's flight path and heading angles.

14. The method of claim 12, wherein the HAFM comprises:
(a) computing a heading angle error (e_{γ}=γ_{f}−γₗ);
(b) controlling the follower's angular speed as ω_{f}=ωₗ+K_{γ1} sign(e_{γ}) for a homogeneous leader or
$${ω}_{f} = \frac{{a}_{l}}{{v}_{l}} + {K}_{γ 2} sign ( {e}_{γ} )$$
for a heterogeneous leader steered by lateral acceleration (aₗ), where K_{γ1}, K_{γ2}>0.

15. The method of claim 12, wherein the FLFM comprises:
(a) computing a line-of-sight error (e_{θ}=θ−θ_{d});
(b) controlling the follower's angular speed as
$${ω}_{f} = \frac{r [ ( λ - \frac{2 \dot{r}}{r} ) \dot{θ} + {K}_{θ} sign ( ζ ) ] + {v}_{l} {ω}_{l} cos {σ}_{l}}{{v}_{l} cos {σ}_{l} + {K}_{r} sign ( {e}_{r} )} , where ζ = {\dot{e}}_{θ} + λ {e}_{θ} , η \geq {v}_{l} + {v}_{f} , {K}_{θ} > \frac{n λ}{r} and λ > 0.$$

16. The method of claim 12, wherein the FBFM comprises:
(a) computing a bearing angle error (e_{σ}=σ_{f}−σ_{fd});
(b) controlling the follower's angular speed as
$${ω}_{f} = \frac{{v}_{l} ( sin {σ}_{l} - cos {σ}_{l} tan {σ}_{f} )}{r} + \frac{{K}_{r} sign ( {e}_{r} ) tan {σ}_{f}}{r} - \frac{{K}_{σ}}{{b}^{2} - {e}_{σ}^{2}} {e}_{σ} . \qquad ( 37 )$$
where Kσ>0, and using a Barrier Lyapunov Function to ensure e_{σ} remains within (−b,b).

17. The method of claim 12, wherein the CBFM comprises:
(a) computing a bearing angle error (e_{σ}=σ_{f}−σ_{fd}) with constraints −c<e_{σ}<d, where c=σ_{fd}−a, d=b−σ_{fd};
(b) controlling the follower's pitch and yaw angular speeds (ω_{γf}, ω_{χf}) to minimize the control effort
$$J = {}^{⌣} \sqrt{\frac{{ω}_{{γ}_{f}}^{2}}{{w}_{1}^{2}} + \frac{{ω}_{{χ}_{f}}^{2}}{{w}_{2}^{2}}} ,$$
using an effective angular control input
$${U}_{f} = - ( \frac{cos {γ}_{f} sin θ cos ( {χ}_{f} - ψ ) - sin {γ}_{f} cos θ}{sin {σ}_{f}} \dot{θ} - \frac{cos {γ}_{f} cos θ sin ( {χ}_{f} - ψ )}{sin {σ}_{f}} \dot{ψ} ) - ( \frac{q ( {s}_{d} )}{{c}^{2} - {e}_{σ}^{z}} + \frac{1 - q ( {e}_{σ} )}{{d}^{2} - {e}_{σ}^{2}} ) {K}_{σ} {e}_{σ} ,$$
where q(e_{σ})=1 if e_{σ}>0, else (0), and K_{σ}>0;
(c) using an asymmetric Barrier Lyapunov Function to ensure σ_{f} remains within ((a,b)).

18. The method of claim 12, wherein the follower UAV operates in a GPS-denied environment using relative measurements obtained from onboard sensors selected from the group consisting of radar, lidar, and vision-based sensors.

19. The method of claim 12, wherein the leader UAV and the follower UAV are heterogeneous, with the leader steered by lateral acceleration (aₗ) and the follower steered by linear and angular speeds.

20. The method of claim 12, wherein the formation maneuver emulates human pilot behavior, enabling anticipatory maneuvers to maintain a tactically advantageous position behind the leader, defined by a ring angle (p) in 2D or a partial hemispherical shell in 3D.

21.-29. (canceled)
